(19) United States
(12) Patent Application Publication
(10) Pub. No.: US 2026/0360198 A1
(43) Pub. Date: Nov. 12, 2026

(54) VISUALIZED EDIT HISTORY TIMELINE FOR VEHICLE MODEL PARAMETER ADJUSTMENTS

(71) Applicant: Applied Intuition, Inc., Mountain View, CA (US)

(72) Inventor: Chirag Bangera, Canton, MI (US)

(21) Appl. No.: 19/318,072

(22) Filed: Sep. 3, 2025

Related U.S. Application Data
(60) Provisional application No. 63/803,440, filed on May 9, 2025.

(51) Int. Cl. G07C 5/08

(52) U.S. Cl. CPC G07C 5/085; G07C 5/0825

(57) ABSTRACT

An embodiment includes recording a first transaction comprising a first change to a vehicle system architecture from a first state to a second state at a first time. An embodiment includes recording a second transaction comprising a second change to the vehicle system architecture from the second state to a third state at a second time later than the first time. An embodiment includes displaying, in a user interface at a third time later than the second time, a sequence of transactions including the first transaction and the second transaction, the sequence of transactions resulting in a fourth state of the vehicle system architecture. An embodiment includes reversing, in response to a selection of the first transaction in the user interface, the first transaction, the reversing changing the vehicle system architecture from the fourth state to the first state, the reversing recorded as a third transaction.

### CROSS-REFERENCE OF RELATED APPLICATION

This application claims the benefit of U.S. Provisional Application No. 63/803440, filed on May 9, 2025, which is incorporated herein in its entirety.

### TECHNICAL FIELD

The present disclosure generally relates to automated and autonomous vehicles, and more particularly to visualized edit history timeline for vehicle model parameter adjustments.

### BACKGROUND

A vehicle system architecture, also referred to as a vehicle model, is a definition of interconnected components and their relationships spanning sensor fusion, decision-making, actuation, and physical vehicle dynamics. Such an architecture applies to wholly human-operated vehicles, wholly autonomous vehicles, and vehicles that combine human and machine operations. In practice, a vehicle system architecture encompasses both functional processes—such as automatically adjusting headlights when an oncoming vehicle is detected, adapting windshield wiper operation to changing rainfall, or deciding whether to lock the vehicle when a user activates a locking function—and vehicle dynamics models, which mathematically represent how the vehicle responds to driver inputs and environmental conditions. Vehicle dynamics models define subsystems such as suspension, tires, steering, braking, and powertrain, along with their interactions, in order to capture performance characteristics required to meet regulatory standards, engineering objectives, or project expectations. The model may also include identifiers of validation or verification tests, such as lane-change maneuvers, braking performance evaluations, or ride comfort assessments, that establish the model's accuracy.

A vehicle system architecture includes one or more requirements—specifications or characteristics that a deliverable must satisfy to comply with regulations, achieve business goals, or meet stakeholder expectations. A component may also include one or more identifiers of tests of the component's function. A vehicle system architecture is distinct from the software used to implement it. However, both the architecture itself and its software implementation are typically stored in one or more data repositories accessible using presently available data management techniques.

### SUMMARY

Some embodiments of the present disclosure provide a computer-implemented method for visualized edit history timeline for vehicle model parameter adjustments. The method includes recording a first transaction comprising a first change to a vehicle system architecture from a first state to a second state at a first time; recording a second transaction comprising a second change to the vehicle system architecture from the second state to a third state at a second time later than the first time; displaying, in a user interface at a third time later than the second time, a sequence of transactions including the first transaction and the second transaction, the sequence of transactions resulting in a fourth state of the vehicle system architecture; and reversing, in response to a selection of the first transaction in the user interface, the first transaction, the reversing changing the vehicle system architecture from the fourth state to the first state, the reversing recorded as a third transaction.

Some embodiments of the present disclosure provide a non-transitory computer-readable medium storing a program for visualized edit history timeline for vehicle model parameter adjustments. The program, when executed by a computer, configures the computer to record a first transaction comprising a first change to a vehicle system architecture from a first state to a second state at a first time; record a second transaction comprising a second change to the vehicle system architecture from the second state to a third state at a second time later than the first time; display, in a user interface at a third time later than the second time, a sequence of transactions including the first transaction and the second transaction, the sequence of transactions resulting in a fourth state of the vehicle system architecture; and reverse, in response to a selection of the first transaction in the user interface, the first transaction, the reversing changing the vehicle system architecture from the fourth state to the first state, the reversing recorded as a third transaction.

Some embodiments of the present disclosure provide a system for visualized edit history timeline for vehicle model parameter adjustments. The system comprises a processor and a non-transitory computer readable medium storing a set of instructions, which when executed by the processor, configure the processor to record a first transaction comprising a first change to a vehicle system architecture from a first state to a second state at a first time; record a second transaction comprising a second change to the vehicle system architecture from the second state to a third state at a second time later than the first time; display, in a user interface at a third time later than the second time, a sequence of transactions including the first transaction and the second transaction, the sequence of transactions resulting in a fourth state of the vehicle system architecture; and reverse, in response to a selection of the first transaction in the user interface, the first transaction, the reversing changing the vehicle system architecture from the fourth state to the first state, the reversing recorded as a third transaction.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement a visualized edit history timeline for vehicle model parameter adjustments, according to some embodiments.

FIG. 2 is a block diagram illustrating details of a system for a visualized edit history timeline for vehicle model parameter adjustments, according to some embodiments.

FIG. 3 depicts a block diagram of an example configuration for a visualized edit history timeline for vehicle model parameter adjustments, in accordance with an illustrative embodiment.

FIG. 4 depicts examples of a visualized edit history timeline for vehicle model parameter adjustments, in accordance with an illustrative embodiment.

FIG. 5 depicts a flowchart of an example process for a visualized edit history timeline for vehicle model parameter adjustments. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Maintaining a vehicle system architecture presents challenges. There is presently no readily available, easily accessible, and visually organized record of changes made to vehicle model parameters or other aspects of a vehicle system architecture. Instead, users making changes to a vehicle system architecture had to rely on memory or manual tracking methods (e.g., spreadsheets, notes) to understand a sequence of adjustments. As well, reverting to previous states of a vehicle model or comparing different versions was challenging. Without a clear history, users couldn't easily identify specific changes and undo them, or see how different parameter values affected simulation results. They would just have to undo and hope their model is in the correct state.

One approach to solving this problem involves undo/redo buttons, functionality allowing users to step back or forward through a linear list of actions. However, this approach offers a limited history depth, doesn't provide a comprehensive overview of changes, is difficult to compare non-sequential versions, and lacks detailed information about each change (e.g., specific parameter values, timestamps, user information). Another approach to solving this problem uses a version control system (VCS) to store text-based parameter files to track changes over time. However, this approach requires technical expertise in using VCS, is not user-friendly for non-programmers, doesn't provide a visual representation of changes, is limited to text-based parameter files, and doesn't integrate seamlessly with a user interface of software used to maintain the vehicle system architecture. Another approach to solving this problem uses a user interface to visualize a timeline of changes to a file repository, but because the user interface shows changes at the file level, it doesn't provide the fine-grained, parameter-level tracking needed. For example, a user cannot easily see that the LEN_SM parameter changed from 2 to 1 within a specific file. A file repository also lacks contextual information that's crucial in a simulation environment. In addition, a file repository user interface is primarily designed for software developers and can be overwhelming for users who are not familiar with version control concepts. A file repository user interface also does not provide a real-time, interactive visualization of parameter changes within the program being used to make parameter changes. Thus, users have to manually track their edits in a separate program.

Embodiments of the present disclosure address the above identified problems by implementing a visualized edit history timeline for vehicle model parameter adjustments. An embodiment provides a visual, interactive timeline that addresses the problem of managing and understanding changes in vehicle model parameters and other changes to a vehicle system architecture within a simulation editor. An embodiment solves the problem by:
Centralizing and Displaying Edit History: All adjustments are recorded and presented in a chronological, user-friendly timeline. The timeline provides a clear record of who made what changes and when.
Providing Detailed Change Information: Each entry in the timeline shows the specific parameter changed, its previous and new values, timestamps, and relevant context (e.g., library, category).
Enabling Easy Navigation and Reversion: Users can easily navigate through the edit history, jump to specific points in time, and revert to previous states of the vehicle model with a single click.

In particular, an embodiment records a first transaction comprising a first change to a vehicle system architecture from a first state to a second state at a first time; records a second transaction comprising a second change to the vehicle system architecture from the second state to a third state at a second time later than the first time; displays, in a user interface at a third time later than the second time, a sequence of transactions including the first transaction and the second transaction, the sequence of transactions resulting in a fourth state of the vehicle system architecture; and reverses, in response to a selection of the first transaction in the user interface, the first transaction, the reversing changing the vehicle system architecture from the fourth state to the first state, the reversing recorded as a third transaction.

An embodiment records one or more transactions in a sequence of transaction. Each transaction includes a change to a vehicle system architecture from a first state to a second state at a particular time. Some non-limiting examples of data an embodiment records in a transaction are a name of a model parameter or other portion of a model that was changed in the transaction (e.g., HT_SM, X_LENGTH, LEN_SM, #CheckBox3), values of the changed parameter or other portion of a model before and after the transaction, a timestamp of the transaction, library or category information providing context about the location and type of the changed parameter (e.g., Library: Vehicle: Sprung Mass, Category: Exotic Sports Car), and change status data indicating whether the transaction is in the Current, Future, or Previous state relative to the user's current position in a sequence of recorded transactions.

An embodiment displays recorded transactions in a sequence of transactions, in a user interface. An embodiment implements one more interactive navigation features with which the user navigates the displayed sequence of transactions. Some non-limiting examples of interactive navigation features are a slider control allowing a user to jump to a specific point in the sequence, an ability to select an individual transaction to view more detailed information or navigate to a specific state before or after a specific transaction, an original state entry representing the initial state of the vehicle model before any edits were made, a vertical timeline (e.g., on the left or right side of the display) allowing a user another method of jumping to a specific point in the sequence, a library navigation ability allowing the user to navigate to a specific library or other context of the change in a transaction, visual indicators such as color coding (e.g., to visually distinguish between “Current,” “Future,” and “Previous” changes) and icons or checkmarks providing visual cues for the status of a transaction and the availability of additional information.

In some embodiments, a user can filter the sequence to show only changes made to a specific parameter or set of parameters. For example, the user might select the LEN_SM parameter from a filter dropdown or other user interface element to display only entries related to changes in LEN_SM. A user can filter the sequence to show only changes made by a specific user. For example, the user might select User A from a filter dropdown or other user interface element to display only changes made by User A. A user can filter the sequence to show only changes made within a specified time range. For example, the user might enter “10:00 AM” and “12:00 PM” to display only changes made between those times.

In some embodiments, a user can search for a particular transaction by entering a search term in the user interface to highlight or filter entries that match the search term. For example, the user might enter “2600” and the entry where the X_LENGTH parameter was changed to 2600 would be highlighted. In some embodiments, a user can create a branch or fork in the timeline to explore alternative changes (e.g., parameter adjustments). For example, a user might create a branch at a specific point in the timeline, make changes in that branch, and compare the results with the main timeline or other branches. In some embodiments, a user can also compare elements of a vehicle system architecture state (e.g., parameter values) at two different points in a transaction sequence. For example, a user might select the “Original State” and the “Current” state to display a side-by-side comparison of the two states, or only the changes between the two states. In some embodiments, a user can add an annotation or comment to a specific entry in the timeline (e.g., to provide context or an explanation for a change). For example, a user might add a comment to an entry in which the value of the LEN_SM parameter was changed explaining why the value was changed to 1. In some embodiments, a user can export the timeline as a report or file (e.g., in CSV, PDF, JSON, or another format) for documentation or sharing purposes. In some embodiments, transactions are visually reflected in a representation of the vehicle model, highlighting an affected component or parameter. For example, a user might select a transaction in which the X_LENGTH parameter changed and in response an embodiment highlights or animates the corresponding length of the vehicle in the model. Some embodiments generate a transaction summary, for example highlighting or otherwise indicating the most significant or most frequently modified parameters.

For example, a user might open a vehicle model in a model editing application. In the application, a timeline panel with which to view the model's edit history is automatically activated. The user might make changes to various parameters of the vehicle model. An embodiment records each change, including the parameter name, previous and new values, timestamp, and other relevant information. An embodiment updates the timeline panel to reflect each change the user makes, displaying transactions in chronological order. The user can use the slider control, select an individual entry, or use another user interface feature to navigate through the edit history. When an entry is selected, an embodiment displays more detailed information about the transaction, e.g., in a separate panel of the user interface.

A user can choose to revert the vehicle model to a previous state by selecting a transaction in the user interface and entering an appropriate command via the user interface (e.g., an Undo or Revert button or menu item). In response, an embodiment reverses the selected transaction, changing the vehicle system architecture from a current state to the state the selected transaction changed. An embodiment records the reversing in another transaction in the sequence of transactions and displays the reversing in an updated sequence of transactions in the user interface.

A user can choose to redo a previously reversed transaction by selecting the previously reversed transaction in the user interface and entering an appropriate command via the user interface (e.g., a Redo button or menu item). In response, an embodiment reverses the previously reversed transaction, changing the vehicle system architecture to a new state. An embodiment records the redone transaction for display and possible reversion. As the user continues to edit the vehicle model, an embodiment records each change, including the parameter name, previous and new values, timestamp, and other relevant information and updates the timeline panel to reflect each change the user makes, displaying transactions in chronological order. A user has the option to reverse or redo any previous transaction, in any order, in a manner described herein.

The subject technology includes a number of advantageous features. For example, the disclosed solution, provides a visual and intuitive user interface, is integrated with an existing user interface and is user friendly, provides detailed change information, and provides easy navigation and reversion, enhanced collaboration, improved debugging and optimization, reduced errors, improved productivity, enhanced knowledge management, and potential cost savings. The visual and intuitive user interface and transaction timeline provides a clear, visual representation of the edit history, making it easy to understand the sequence and context of changes. Unlike text-based logs or spreadsheets, users can quickly grasp the evolution of the model without having to parse long complex data. The transaction timeline is seamlessly integrated into a vehicle simulation editor's user interface, providing a user-friendly experience without requiring external tools or technical expertise. Unlike version control systems (VCS) or manual tracking, users don't need to switch applications or learn complex commands. Each entry in the transaction timeline provides detailed information about the specific parameter changed, its values, timestamp, and context, enabling precise understanding and analysis that is not available with a simple undo/redo stack or basic logging. The transaction timeline allows users to quickly navigate through the edit history and revert to a specific state anywhere in the timeline (not just the last state) with a single click, simplifying the process of exploring different model configurations. The transaction timeline provides a clear record of who made what changes and when, facilitating collaboration among multiple users and reducing the risk of conflicts or errors, unlike manual tracking or basic logs. Unlike basic logs or limited history features, the transaction timeline provides a comprehensive view of a vehicle model's evolution, making it easier to trace the impact of parameter changes on simulation outcomes and simplifying debugging and optimization efforts. The transaction timeline streamlines the process of managing and understanding vehicle model changes, saving users time and effort as compared to manual tracking and external tools. The timeline's detailed information and clear visual representation reduce the risk of errors associated with manual tracking or incomplete change logs. By simplifying the process of managing and understanding changes as compared to manual tracking and external tools, the transaction timeline enables users to focus on higher-level tasks, such as model development and analysis. The transaction timeline provides more effective record of the model's evolution than obtained using manual tracking and external tools, enabling users to learn from past adjustments and improve future modeling practices. By improving efficiency and reducing errors, the transaction timeline can potentially lead to cost savings in terms of reduced development time and improved simulation accuracy.

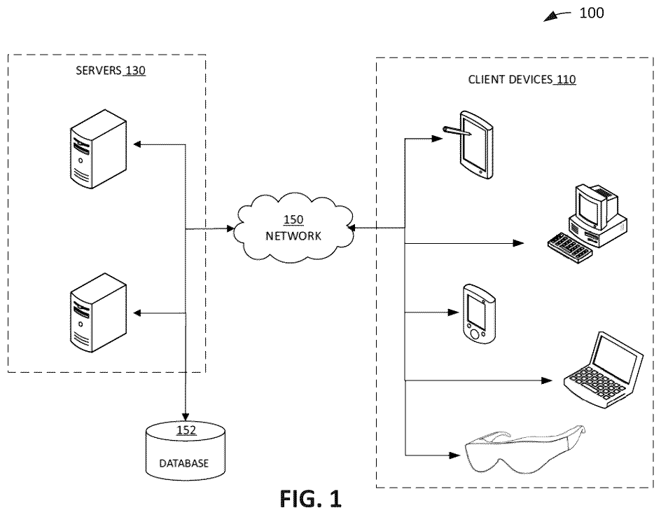

FIG. 1 illustrates a network architecture 100 used to implement a visualized edit history timeline for vehicle model parameter adjustments, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

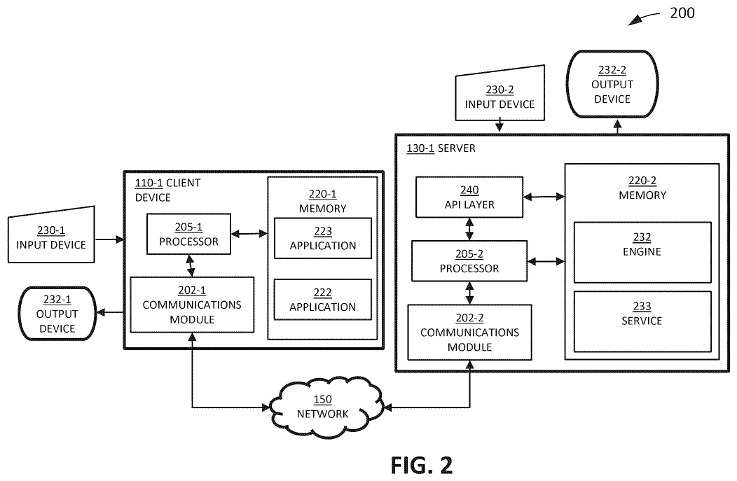

FIG. 2 is a block diagram illustrating details of a system 200 for a visualized edit history timeline for vehicle model parameter adjustments, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

In further examples, input devices 320 may include biometric components, motion components, environmental components, or position components, among a wide array of other components. For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies include electroencephalography (EEG) based BMIs, which record electrical activity in the brain using electrodes placed on the scalp; invasive BMIs, which use electrodes that are surgically implanted into the brain; and optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement visualized edit history timeline for vehicle model parameter adjustments. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide visualized edit history timeline for vehicle model parameter adjustments. The application 223 may communicate with service 233 through API layer 240, for example.

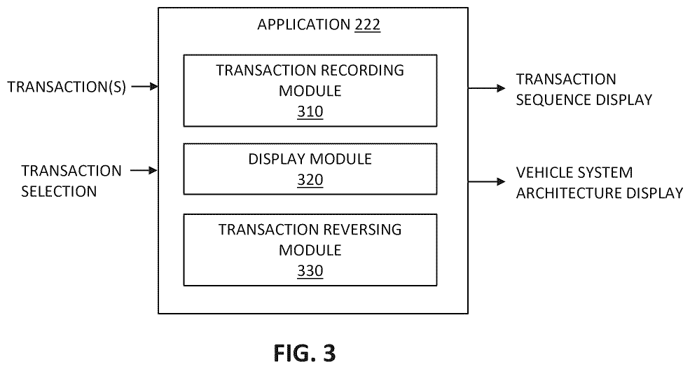

FIG. 3 depicts a block diagram of an example configuration for a visualized edit history timeline for vehicle model parameter adjustments, in accordance with an illustrative embodiment. Application 222 is the same as application 222 in FIG. 2.

Transaction recording module 310 records one or more transactions in a sequence of transactions. Each transaction includes a change to a vehicle system architecture from a first state to a second state at a particular time. Some non-limiting examples of data module 310 records in a transaction are a name of a model parameter or other portion of a model that was changed in the transaction (e.g., HT_SM, X_LENGTH, LEN_SM, #CheckBox3), values of the changed parameter or other portion of a model before and after the transaction, a timestamp of the transaction, library or category information providing context about the location and type of the changed parameter (e.g., Library: Vehicle: Sprung Mass, Category: Exotic Sports Car), and change status data indicating whether the transaction is in the Current, Future, or Previous state relative to the user's current position in a sequence of recorded transactions.

Display module 320 displays recorded transactions in a sequence of transactions, in a user interface. Module 320 implements one more interactive navigation features with which the user navigates the displayed sequence of transactions. Some non-limiting examples of interactive navigation features are a slider control allowing a user to jump to a specific point in the sequence, an ability to select an individual transaction to view more detailed information or navigate to a specific state before or after a specific transaction, an original state entry representing the initial state of the vehicle model before any edits were made, a vertical timeline (e.g., on the left or right side of the display) allowing a user another method of jumping to a specific point in the sequence, a library navigation ability allowing the user to navigate to a specific library or other context of the change in a transaction, visual indicators such as color coding (e.g., to visually distinguish between “Current,” “Future,” and “Previous” changes) and icons or checkmarks providing visual cues for the status of a transaction and the availability of additional information.

In some implementations of module 320, a user can filter the sequence to show only changes made to a specific parameter or set of parameters. For example, the user might select the LEN_SM parameter from a filter dropdown or other user interface element to display only entries related to changes in LEN_SM. A user can filter the sequence to show only changes made by a specific user. For example, the user might select User A from a filter dropdown or other user interface element to display only changes made by User A. A user can filter the sequence to show only changes made within a specified time range. For example, the user might enter “10:00 AM” and “12:00 PM” to display only changes made between those times.

In some implementations of module 320, a user can search for a particular transaction by entering a search term in the user interface to highlight or filter entries that match the search term. For example, the user might enter “2600” and the entry where the X_LENGTH parameter was changed to 2600 would be highlighted. In some implementations of module 320, a user can create a branch or fork in the timeline to explore alternative changes (e.g., parameter adjustments). For example, a user might create a branch at a specific point in the timeline, make changes in that branch, and compare the results with the main timeline or other branches. In some implementations of module 320, a user can also compare elements of a vehicle system architecture state (e.g., parameter values) at two different points in a transaction sequence. For example, a user might select the “Original State” and the “Current” state to display a side-by-side comparison of the two states, or only the changes between the two states. In some implementations of module 320, a user can add an annotation or comment to a specific entry in the timeline (e.g., to provide context or an explanation for a change). For example, a user might add a comment to an entry in which a value of the LEN_SM parameter was changed explaining why the value was changed to 1. In some implementations of module 320, a user can export the timeline as a report or file (e.g., in CSV, PDF, JSON, or another format) for documentation or sharing purposes. In some implementations of module 320, transactions are visually reflected in a representation of the vehicle model, highlighting an affected component or parameter. For example, a user might select a transaction in which the X_LENGTH parameter changed and in response module 320 highlights or animates the corresponding length of the vehicle in the model. Some implementations of module 320 generate a transaction summary, for example highlighting or otherwise indicating the most significant or most frequently modified parameters.

For example, a user might open a vehicle model in a model editing application. In the application, a timeline panel with which to view the model's edit history is automatically activated. The user might make changes to various parameters of the vehicle model. Module 320 records each change, including the parameter name, previous and new values, timestamp, and other relevant information. Module 320 updates the timeline panel to reflect each change the user makes, displaying transactions in chronological order. The user can use the slider control, select an individual entry, or use another user interface feature to navigate through the edit history. When an entry is selected, module 320 displays more detailed information about the transaction, e.g., in a separate panel of the user interface.

A user can choose to revert the vehicle model to a previous state by selecting a transaction in the user interface and entering an appropriate command via the user interface (e.g., an Undo or Revert button or menu item). In response, transaction reversing module 330 reverses the selected transaction, changing the vehicle system architecture from a current state to the state the selected transaction changed. Module 310 records the reversing in another transaction in the sequence of transactions and module 320 displays the reversing in an updated sequence of transactions in the user interface.

A user can choose to redo a previously reversed transaction by selecting the previously reversed transaction in the user interface and entering an appropriate command via the user interface (e.g., a Redo button or menu item). In response, module 330 reverses the previously reversed transaction, changing the vehicle system architecture to a new state. Module 310 records the redone transaction for display and possible reversion. As the user continues to edit the vehicle model, module 310 records each change, including the parameter name, previous and new values, timestamp, and other relevant information and updates the timeline panel to reflect each change the user makes, and module 320 displays transactions in chronological order. A user has the option to reverse or redo any previous transaction, in any order, in a manner described herein.

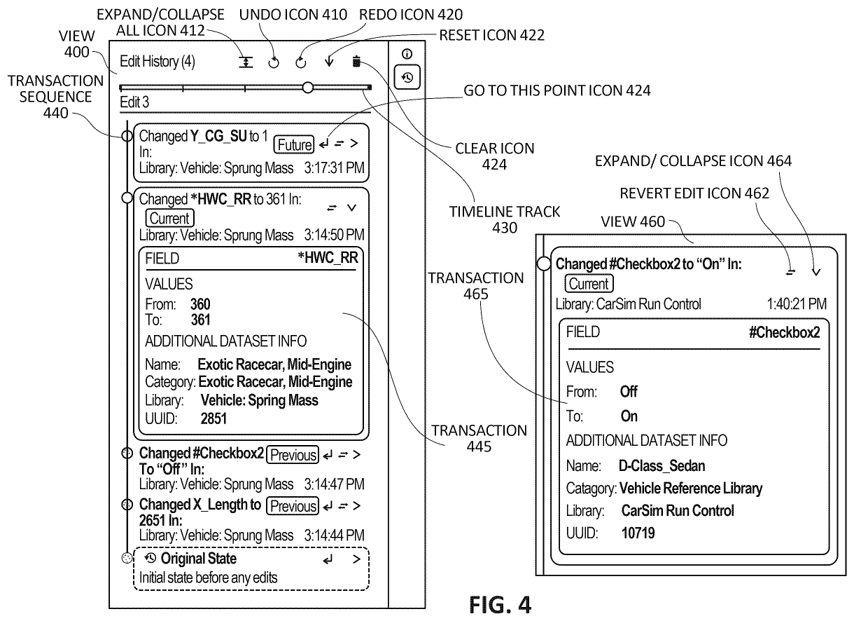

FIG. 4 depicts examples of a visualized edit history timeline for vehicle model parameter adjustments, in accordance with an illustrative embodiment. The example can be executed using application 222 in FIG. 2.

View 400 depicts timeline track 430, transaction sequence 440, and transaction 445 within transaction sequence 440. A user can use timeline track 430 to navigate within transaction sequence 440. Timeline track 430 provides a visual representation of all changes made to a vehicle model dataset during an editing session, allowing a user to navigate through the history, view details of each change, and revert to previous states. Timeline track 430 displays each edit, or transaction, as a point on a horizontal track. The leftmost point represents the original state of the dataset before any edits were made. Each subsequent point to the right represents a single edit action. Thus, timeline track 430 is implemented as a visual slider representing the entire history of edits. Edit ticks are markers along the track indicating individual edits. Hovering over a tick shows a summary of the edit. A draggable position marker indicates the current state being viewed in transaction sequence 440. A position text field displays a description of the current position (e.g., “Original”, “Edit 3”, “Latest Edit”). Below timeline track 430, each edit or transaction in transaction sequence 440 is represented by a card displaying summary information.

A user can navigate through transaction sequence 440 in several ways. A user can click anywhere on timeline track 430 to jump directly to the nearest vehicle system architecture state. A user can click and drag the position marker along the track to scrub through the history. A user can click directly on one of the small tick marks on the track to jump to that specific edit. A user can use undo icon 410 and redo icon 420 in the header to move one step backward or forward in the history. A user can click go to this point icon 424 button on an edit card (visible when the card isn't the current state) to navigate directly to that edit.

Within the displayed transaction sequence, expand/collapse all icon 412 toggles the expanded state of all edit cards simultaneously. Undo icon 410 moves one step back in the history and is enabled only when there are edits to undo. Redo icon 420 moves one step forward in the history and is enabled only when edits have been undone. Reset icon 422 jumps directly back to the original state before any edits were made. Clear icon 424 removes all edits from the history. This action is irreversible and requires confirmation.

The expanded view shows a specific field (e.g., a parameter) that was modified (e.g., #CheckBox2, Z_LENGTH) as well as previous and new values of the modified field. Formatting of the expanded view adapts to the type of field. A checkbox field shows an On or Off setting. A ring control field shows the selected option's label (e.g., “Independent”) and the raw numerical provides details for both the “From” and “To” linked datasets (e.g., Name, Category, Library, UUID). A table field shows a summary of changes (e.g., “changed 5 cells”). For more extensive changes (e.g., more than 10 cells or 20% of the table), the view displays the full “Before” and “After” tables. For fewer changes, the view lists individual cell modifications within the table (e.g., (Row X, Col Y: OldValue→NewValue). A default field type shows previous and new values. Additional vehicle system architecture data about the specific vehicle system architecture where the transaction occurred, such as name category, library, and a user identifier, are also displayed. Edit cards also display tags indicating their status relative to the current position marker (e.g., Current, Previous, Future). The very first state, before any edits, is represented by an “Original State” card at the bottom of the list.

View 460 depicts more detail of transaction 465 in transaction sequence 440 once a user chooses to see the additional detail. Each edit card provides a summary of the change. A user can expand any card to view more details by clicking on it or using expand/collapse icon 464. Revert edit icon 462 creates a new edit that undoes the specific change represented by this card. This is useful for undoing an older edit without reverting all subsequent changes. This button is only available on non-current edit cards. (Expand/collapse icon 464 and evert edit icon 462 are also available in the transactions depicted in view 400.) A “go to this point” icon (not shown) navigates the timeline to make this edit the current state. This button is only available on non-current edit cards.

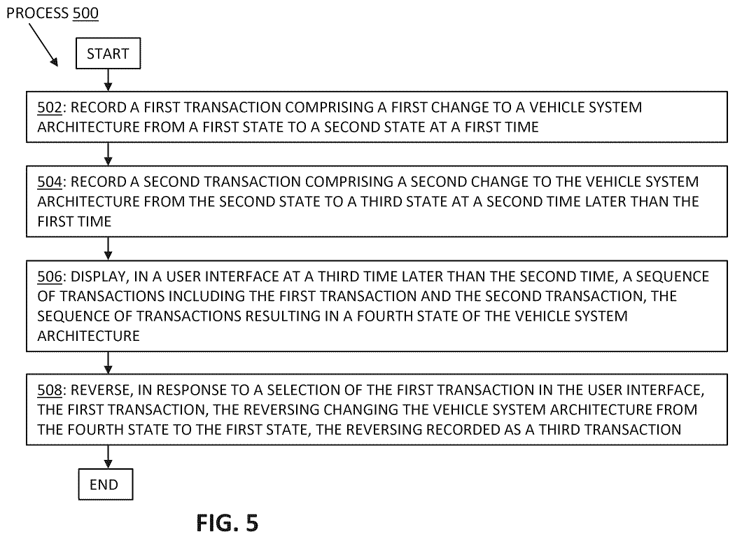

FIG. 5 depicts a flowchart of an example process for a visualized edit history timeline for vehicle model parameter adjustments, in accordance with an illustrative embodiment. Process 500 can be implemented in application 222 in FIG. 2.

At block 502, the process records a first transaction comprising a first change to a vehicle system architecture from a first state to a second state at a first time. At block 504, the process records a second transaction comprising a second change to the vehicle system architecture from the second state to a third state at a second time later than the first time. At block 506, the process displays, in a user interface at a third time later than the second time, a sequence of transactions including the first transaction and the second transaction, the sequence of transactions resulting in a fourth state of the vehicle system architecture. At block 508, the process reverses, in response to a selection of the first transaction in the user interface, the first transaction, the reversing changing the vehicle system architecture from the fourth state to the first state, the reversing recorded as a third transaction. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
recording a first transaction comprising a first change to a vehicle system architecture from a first state to a second state at a first time;
recording a second transaction comprising a second change to the vehicle system architecture from the second state to a third state at a second time later than the first time;
displaying, in a user interface at a third time later than the second time, a sequence of transactions including the first transaction and the second transaction, the sequence of transactions resulting in a fourth state of the vehicle system architecture; and
reversing, in response to a selection of the first transaction in the user interface, the first transaction, the reversing changing the vehicle system architecture from the fourth state to the first state, the reversing recorded as a third transaction.

2. The computer-implemented method of claim 1, further comprising:
displaying, in the user interface subsequent to recording the third transaction, an updated sequence of transactions including the third transaction, the updated sequence of transactions resulting in a fifth state of the vehicle system architecture; and
reversing, in response to a selection of the third transaction in the user interface, the third transaction, the reversing changing the vehicle system architecture from the fifth state to a sixth state, the reversing recorded as a fourth transaction.

3. The computer-implemented method of claim 1, further comprising:
displaying, in the user interface at the third time, in response to the selection of the first transaction in the user interface, additional detail of the first transaction.

4. The computer-implemented method of claim 1, further comprising:
displaying, in the user interface at the third time, a user interface element implementing navigation through the sequence of transactions.

5. The computer-implemented method of claim 1, wherein recorded data of a transaction in the sequence of transactions comprises a name of a vehicle system architecture parameter and a previous value and a new value of the vehicle system architecture parameter.

6. The computer-implemented method of claim 5, wherein the displayed sequence of transactions is filterable by vehicle system architecture parameter name.

7. The computer-implemented method of claim 1, wherein recorded data of a transaction in the sequence of transactions comprises an identifier of a user performing the transaction.

8. The computer-implemented method of claim 7, wherein the displayed sequence of transactions is filterable by user identifier.

9. The computer-implemented method of claim 1, wherein recorded data of a transaction in the sequence of transactions comprises a timestamp of the transaction.

10. The computer-implemented method of claim 9, wherein the displayed sequence of transactions is filterable by time range.

11. A non-transitory computer-readable medium storing a program, which when executed by a computer, configures the computer to:
record a first transaction comprising a first change to a vehicle system architecture from a first state to a second state at a first time;
record a second transaction comprising a second change to the vehicle system architecture from the second state to a third state at a second time later than the first time;
display, in a user interface at a third time later than the second time, a sequence of transactions including the first transaction and the second transaction, the sequence of transactions resulting in a fourth state of the vehicle system architecture; and
reverse, in response to a selection of the first transaction in the user interface, the first transaction, the reversing changing the vehicle system architecture from the fourth state to the first state, the reversing recorded as a third transaction.

12. The non-transitory computer-readable medium of claim 11, wherein the program, when executed by the computer, further configures the computer to:
display, in the user interface subsequent to recording the third transaction, an updated sequence of transactions including the third transaction, the updated sequence of transactions resulting in a fifth state of the vehicle system architecture; and
reverse, in response to a selection of the third transaction in the user interface, the third transaction, the reversing changing the vehicle system architecture from the fifth state to a sixth state, the reversing recorded as a fourth transaction.

13. The non-transitory computer-readable medium of claim 11, wherein the program, when executed by the computer, further configures the computer to:
display, in the user interface at the third time, in response to the selection of the first transaction in the user interface, additional detail of the first transaction.

14. The non-transitory computer-readable medium of claim 11, wherein the program, when executed by the computer, further configures the computer to:
display, in the user interface at the third time, a user interface element implementing navigation through the sequence of transactions.

15. The non-transitory computer-readable medium of claim 11, wherein recorded data of a transaction in the sequence of transactions comprises a name of a vehicle system architecture parameter and a previous value and a new value of the vehicle system architecture parameter.

16. The non-transitory computer-readable medium of claim 15, wherein the displayed sequence of transactions is filterable by vehicle system architecture parameter name.

17. The non-transitory computer-readable medium of claim 11, wherein recorded data of a transaction in the sequence of transactions comprises an identifier of a user performing the transaction.

18. The non-transitory computer-readable medium of claim 17, wherein the displayed sequence of transactions is filterable by user identifier.

19. The non-transitory computer-readable medium of claim 11, wherein recorded data of a transaction in the sequence of transactions comprises a timestamp of the transaction.

20. A system comprising:
a processor; and
a non-transitory computer readable medium storing a set of instructions, which when executed by the processor, configure the system to:
record a first transaction comprising a first change to a vehicle system architecture from a first state to a second state at a first time;
record a second transaction comprising a second change to the vehicle system architecture from the second state to a third state at a second time later than the first time;
display, in a user interface at a third time later than the second time, a sequence of transactions including the first transaction and the second transaction, the sequence of transactions resulting in a fourth state of the vehicle system architecture; and
reverse, in response to a selection of the first transaction in the user interface, the first transaction, the reversing changing the vehicle system architecture from the fourth state to the first state, the reversing recorded as a third transaction.
